(19) United States
(12) Patent Application Publication
(10) Pub. No.: US 2024/0295534 A1
(43) Pub. Date: Sep. 5, 2024

(54) Titrator Grid Mounting System

(71) Applicant: Todd A. Balisky, Corona, CA (US)

(72) Inventor: Todd A. Balisky, Corona, CA (US)

(73) Assignee: Liquid Analysis Systems, Inc., Corona, CA (US)

(21) Appl. No.: 18/595,416

(22) Filed: Mar. 5, 2024

Related U.S. Application Data
(60) Provisional application No. 63/450,070, filed on Mar. 5, 2023.

(51) Int. Cl. G01N 31/16

(52) U.S. Cl. CPC G01N 31/16

(57) ABSTRACT

Improvements in a mounting system for components of a chemical analyzer or chemical titrator, comprising a grid-patterned panel. The standardized grid allows for titration components to fit on common backing plates from a single 1×1 plate and integer multiples of that size. The housing provides inlet and outlet connections for power, pneumatics, hydraulics, and fluid exchange. The inlet and outlet connections can be easily attached to the titration components for quick configuration based upon the requirements of the chemical analyzer or chemical titrator. As devices and technology changes and advances, the plate or multiple plates can be increased or decreased to support the technology without requiring a change to the base grid system within the housing.

### CROSS-REFERENCE TO RELATED APPLICATIONS

This application claims the benefit of Provisional Application Ser. No. 63/450,070 filed Mar. 5, 2023, the entire contents of which is hereby expressly incorporated by reference herein.

### PRIOR ART

U.S. Published patent application numbers 2004/0065547 was published on Apr. 8, 2004, and 2003/0121799 that was published on Jul. 3, 2003, both to Russell Stevens et al., and is titled. Real-Time Component Monitoring and Replenishment System for Multicomponent Fluids. This publication discloses a multicomponent fluid composition monitoring and compositional control system, in which a component analysis is effected by titration or other analytical procedure, for one or more components of interest, and a computational means then is employed to determine and responsively adjust the relative amount or proportion of the one or more components in the multicomponent fluid composition, to maintain a predetermined compositional character of the multicomponent fluid composition. While these publications disclose a titration system the components in the housing are not reconfigurable.

U.S. Published patent application number 2005/0170513 was published on Aug. 4, 2005, to Leon E. Moore and is titled Analytical Rotor System for Titration Testing. This published application discloses an analytical rotor system comprised of a rotor and interface. The rotor defines a plurality of chambers configured to process a sample to perform a titration test in response to centrifugal force. The rotor also defines a plurality of capillaries configured to transfer the sample between the chambers in response to the centrifugal force. The interface is configured to couple to the rotor and to an analytical device that spins the rotor to provide the centrifugal force. While these publications disclose a titration system the different testing components are in a rotor system and not on a configurable mounting grid.

What is needed is a housing with an internal grid that allows for different configurations of titration components. The titrator grid mounting system disclosed in this document provides the solution.

### BACKGROUND OF THE INVENTION

Titration and related analytical methods of colorimetry and spectroscopy are well established in chemical process and other industries where they are used for process characterization and control. These can be manual or automated methods, the latter requiring additional equipment set up. This is particularly the case for unattended, online methods requiring automated sampling, aliquoting, mixing, cleaning, and so on. This set up varies from site to site to accommodate, for example, differing sample conditions and analytical requirements. Hence there is a benefit in having a highly configurable system where components such as valves, pumps, syringe pumps, a mixer, and a reaction cell can be arranged as needed. Essentially, this becomes a standardized mounting system for the varied components, which at the same time accommodates all the fluidic and electronic requirements.

### SUMMARY OF THE INVENTION

It is an object of the titrator grid mounting system to provide a standardized grid system. The standardized grid allows for titration components to fit on common backing plates. The backing plates can then be installed or interchanged based upon the requirements for titration. Each backing plate can be a single 1×1 plate or an integer multiple of that size such as 1×2, 1×3, or 2×2 as required. This allows for retaining a smaller inventory. The plates can be configured in larger grids and arranged to accommodate the end titration component.

It is another object of the titrator grid mounting system to include a housing that supports the grid system. The housing provides inlet and outlet connections for power, pneumatics, hydraulics, and fluid exchange. The inlet and outlet connections can be easily attached to the titration components for quick configuration based upon the requirements of the chemical analyzer or chemical titrator. The housing can be provided in one or more standard sizes depending upon customer requirements.

It is still another object of the titrator grid mounting system to use component mounting plates that are attached, which plates are a consistent size or multiple of that size, to facilitate rapid and variable fixture of the mounted components. As devices change in size as technology changes and advances, the plate or multiple plates can be increased or decreased to support the technology without requiring a change to the base grid system within the housing.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows the entire assembly with the door opened to show an embodiment with the mounting electrical support components.

FIG. 2 shows the bare grid panel.

FIG. 3 shows a first example of a grid plate.

FIG. 4 shows a second example of a grid plate with a syringe pump.

FIG. 5 shows the plunger in a sample dispense mode.

FIG. 6 shows a grid plate with a drain.

FIG. 7 shows a grid plate with terminal block(s) and a valve plate.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

Item Numbers and Description

| | |
|---|---|
| 20 mounting system | 21 enclosure |
| 22 door hinge | 23 connection port |
| 24 power switch | 25 frame |
| 26 inner hinge | 27 inner lock |
| 28 clip | 30 grid pane |
| 31 open pocket(s) | 32 fastener hole(s) |
| 33 lock location | 34 hinge recess |
| 40 1 × 1 blank grid | 41 1 × 2 blank grid |
| 50 test cell grid plate | 51 vacuum head |
| 52 tube | 53 cup or base |
| 60 pump grid plate | 70 valve grid plate |
| 71 drain head | 72 terminal block(s) |
| 73 solenoid | 74 mounting hole(s) |
| 80 syringe plate | 81 syringe motor |
| 82 syringe controls | 83 chamber |
| 98 up | 99 rotate |

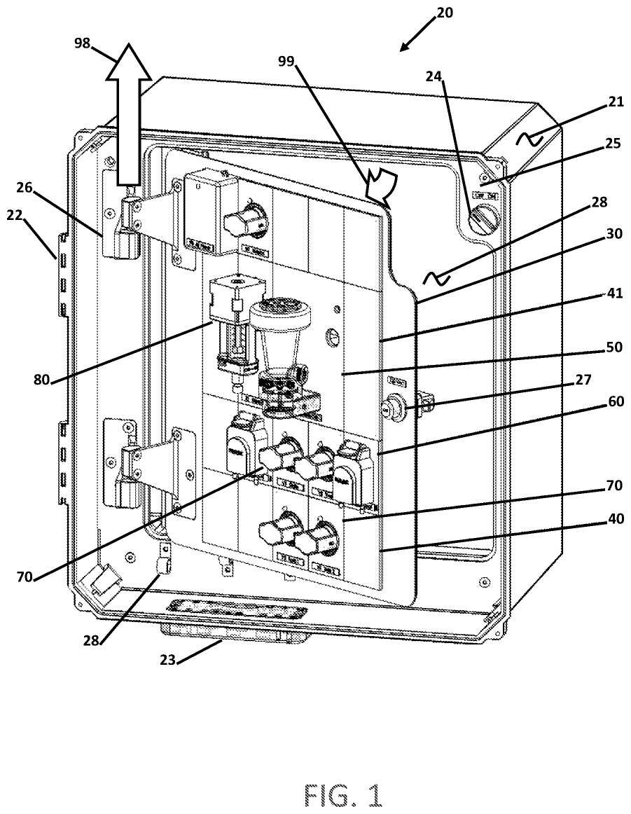

FIG. 1 shows the entire assembly of the chemical analyzer grid patterned mounting system 20 with the enclosure front door removed. The entire assembly consists of an enclosure 21 suitable for an industrial environment, an internal fixed rear panel 28 for mounting electrical support components (not part of the grid mounting system), and a grid panel 30, typically attached via an inner hinge 26 and frame to the enclosure 21. The enclosure 21 has an outer door hinge 22 where a door is removably installed. Within the enclosure 21 in an internal hinge with pins that allows the grid panel 30 to rotate 99 and lifted up 98 to remove or interchange an entire loaded or blank grid panel 30.

At the bottom of the enclosure 21 is a connection port 23 for connecting power, hoses, pneumatic, hydraulic, or vacuum connections that can be connected to the chemical analyzer or titrator working internal components. The embodiment shown has a power switch 24 on the frame 25 of the enclosure 21. There is also an inner lock 27 to secure the grid panel 30 door in the enclosure 21. The back of the enclosure 21 has one or a plurality of clips 28 for securing wiring and or tubes/hoses from the connection port 23 to the titration or chemical analyzer components, directing them to be routed along the hinge axis to minimize tension on them while opening the panel 30.

The grid panel 30 is shown with at least one 1×1 blank grid(s) 40 and at least one 1×2 blank grid(s) 41. The grid panel 30 also includes at least one test cell grid plate 50, at least one pump grid plate 60, at least one valve grid plate and at least one syringe plate 80, a pressure plate with blank plates occupying any remaining spaces. An additional figure shows a view of a bare grid panel with no components installed.

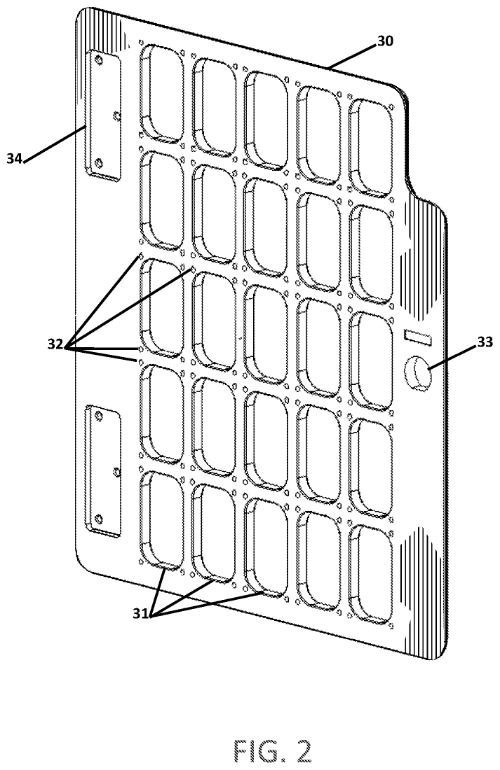

FIG. 2 shows the bare grid panel 30. In this embodiment there are a plurality of open pockets 31 in a grid of 5 wide by 5 tall. While a matrix of 5×5 is shown in this embodiment, the matrix can have less than 5 either horizontal or vertical or more than 5 either horizontal or vertical. The open pockets are shown a having rectangular openings that pass through the grid panel 30. While the openings are shown as rectangular in a vertical orientation, they could be other shapes and orientations including, but not limited to square, round, pentagonal, diamond or octagonal. At one or more locations around the open pockets 31 are fastener locations, shown as fastener holes 32 for securing the titration or chemical analyzer components thereon.

A titration or chemical analyzer components can fit in a single open pocket 31 or can span over two or more open pockets 31 as needed based upon size or design. The bare grid panel 30 is shown as a hinge-mounted swing panel with hinge recesses 34. The grid panel 30 is also shown with a lock location 33 that is shown passing through the grid panel for securing the grid panel 30 in a closed, locked and secured relationship within the mounting system enclosure.

As shown, each grid open pocket 31 has the same aspect ratio and size, facilitating component grid plates of the same size or multiple of the same size to be mounted anywhere on the panel. This flexibility allows for rapid and cost-effective need-driven configuration.

The vertical open pockets 31 are configured for mounting sub-component(s) on both sides of the bare grid panel 30 for combining a fluidic sub-component and an electrical sub-component within the open pocket(s) 31. This provides a separate wet section on a first side of the bare grid panel 30 and a separate dry section on a second side of the bare grid panel 30. A hinge is mounted to the hinge recess 34 to provide access to rear dry section and the front wet section of bare grid panel 30.

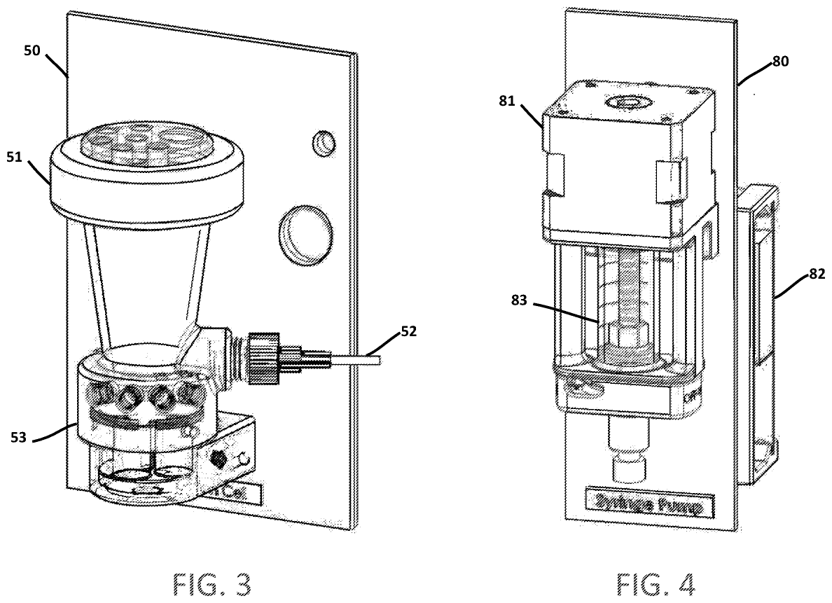

FIG. 3 shows a first example of a grid plate for a test cell grid plate 50. Each grid plate 50 carries a particular functional component, are shown here. The test cell is central to all analysis functions, as it is where the sample and reagents are combined to accomplish the chemical test and measurement. Sensors enter the cell via the cap or side walls. Fluids enter and exit the cell via ports tube 52 in the cap or base 53 (fluidic connections are not shown). The size of this plate is a 2× multiple of the minimum plate size in both its width and height. The top of this test grid plate 50 has a vacuum head 53 or pressure head.

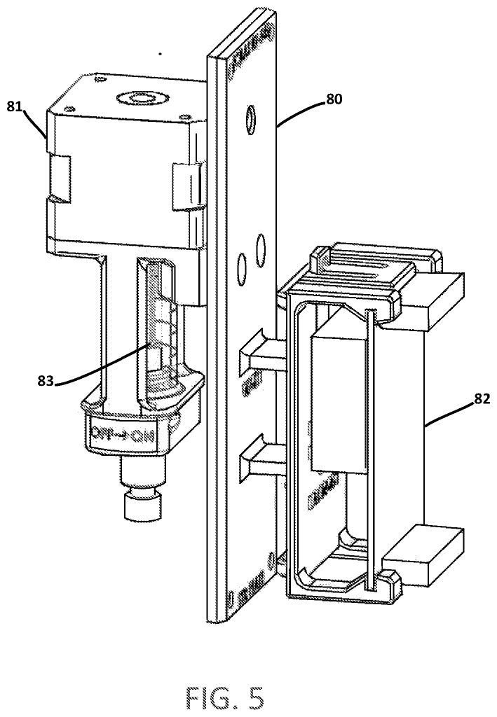

FIG. 4 shows a second example of a grid plate with a syringe plate 80 pump and FIG. 5 shows the plunger in a sample dispense mode. The syringe plate 80 pump is used for precision sample and reagent dispensing. It is shown sized as a one standard grid plate width by twice its height. The syringe plate 80 pump has a syringe motor 81, shown as a stepper motor or servo motor above a chamber 83. Behind the syringe plate 80 are syringe controls 82. As with all the plates, related and supporting electrical syringe control 82 components are mounted on the backside of the syringe plate 80 to complete the module.

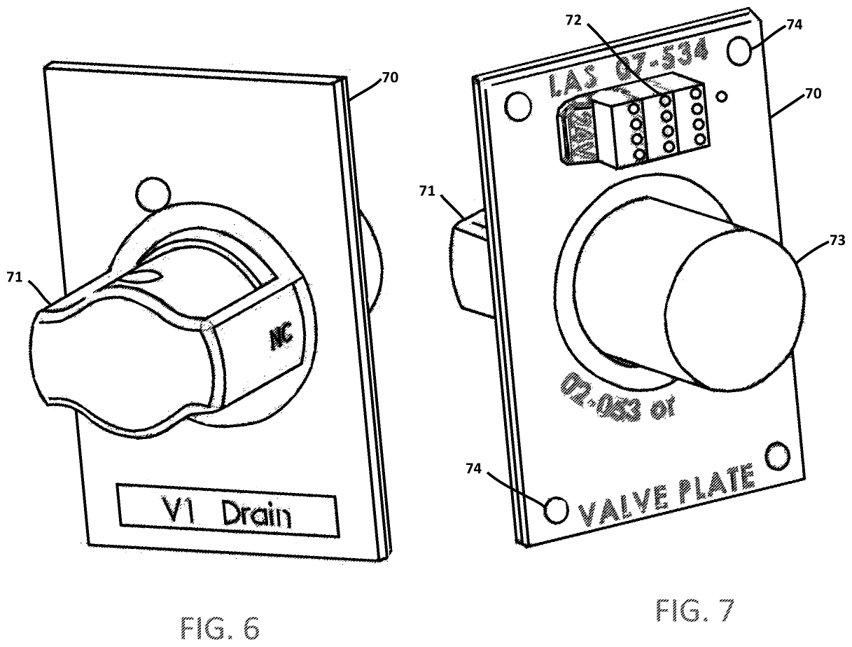

FIG. 6 shows a grid plate as a drain valve grid plate 70 with a drain head 71 the extends from the front of the valve grid plate 70. The drain valve grid plate 70 for the valve component. This example occupies the size of the smallest single plate for a single open pocket (as shown in FIG. 2). This critical function drain valve grid plate 70 is optimally located beneath cell plate 50 as shown in FIG. 1.

FIG. 7 shows a grid plate with terminal block(s) and a valve grid plate 70.

Again, supporting electrical components of the drain head 71, in this case terminal blocks 72 and solenoid 73 are on the back side of the valve grid plate 70, keeping them included in the modularization using the mounting holes 74 located on the valve grid plate 70, and isolating them from potential harm by fluids.

In each case, plates are secured to panel 30 with fasteners, such as but not limited to screws from the back side to optimize esthetics on the front side and maintainability via the back. Clips are also contemplated for this attachment for convenience.

Thus, specific embodiments of a chemical analyzer grid patterned mounting system have been disclosed. It should be apparent, however, to those skilled in the art that many more modifications besides those described are possible without departing from the inventive concepts herein. The inventive subject matter, therefore, is not to be restricted except in the spirit of the appended claims.

1. A chemical analyzer grid patterned mounting system comprising:
a grid-patterned panel;
said panel having at least two mounting positions for component mounting plate(s) to be attached thereon;
said component mounting plate(s) having a consistent size or multiple size thereof whereby;
at least two different fixtures are configured for interchangeable mounting thereon.

2. The chemical analyzer grid patterned mounting system according to claim 1, wherein said grid-patterned panel has a plurality of horizontal and a plurality of vertical open pockets.

3. The chemical analyzer grid patterned mounting system according to claim 2, wherein said plurality of horizontal and plurality of vertical open pockets are configured for mounting sub-components on both sides of said grid-patterned panel for combining a fluidic sub-component and an electrical sub-component thereon, thereby creating a separate wet section on a first side of said grid-patterned panel and a separate dry section on a second side of said grid-patterned panel.

4. The chemical analyzer grid patterned mounting system according to claim 3, wherein said grid-patterned panel is hinged to an enclosure thereby providing access to said dry section and said wet section of said grid-patterned panel.

5. The chemical analyzer grid patterned mounting system according to claim 4, wherein said grid-patterned panel is removable from said enclosure.

6. The chemical analyzer grid patterned mounting system according to claim 4, wherein said grid-patterned panel further includes a lock.

7. The chemical analyzer grid patterned mounting system according to claim 4, wherein said enclosure includes a power switch that is separate from said grid-patterned panel.

8. The chemical analyzer grid patterned mounting system according to claim 1, wherein said component mounting plates are configured to accept at least two of a syringe plate, a cell plate, a pump plate, and a pressure plate.

9. The chemical analyzer grid patterned mounting system according to claim 1, wherein said mounting plates are configured as a 1×1 plate a 1×2 plate, a 1×3 plate, a 2×3 plate or a 3×2 plate.

10. The chemical analyzer grid patterned mounting system according to claim 1, wherein said grid-patterned panel is configured as a front wet side and a dry back side.

11. The chemical analyzer grid patterned mounting system according to claim 10, wherein said wet front side allows for fluid movement on said front wet side for fluid connection between said mounting plates.

12. The chemical analyzer grid patterned mounting system according to claim 10, wherein said dry back side is configured for electrical connections between said mounting plates.

13. The chemical analyzer grid patterned mounting system according to claim 1, wherein said mounting system is enclosed in a housing that has inlet and outlet connections for power, pneumatics, hydraulics, and fluid exchange.

14. The chemical analyzer grid patterned mounting system according to claim 1, wherein said mounting system is configured to allow for said component mounting plates to be changed in size as technology changes and advances.

15. The chemical analyzer grid patterned mounting system according to claim 14, wherein said components mounting plates are increased or decreased to support the technology without requiring a change to said grid-patterned panel.

16. The chemical analyzer grid patterned mounting system according to claim 10, wherein a syringe plate has a wet side consisting of syringe motor with syringe controls on said back dry side of said syringe plate.

17. The chemical analyzer grid patterned mounting system according to claim 16, wherein said syringe motor is a stepper motor or a servo motor.

18. The chemical analyzer grid patterned mounting system according to claim 10, wherein a drain plate has a wet side consisting of drain valve with a drain valve controls and a solenoid on said back dry side of said drain plate.

19. The chemical analyzer grid patterned mounting system according to claim 10, wherein a test cell plate has a wet side consisting of at least one port tube and a vacuum head or a pressure head with test cell controls on said back dry side of said test cell plate.

20. The chemical analyzer grid patterned mounting system according to claim 19, wherein said test cell plate is at least two a 1×2 plate.
